(19) United States
(12) Patent Application Publication
(10) Pub. No.: US 2003/0212785 A1
(43) Pub. Date: Nov. 13, 2003

(54) System and method for isolating faulty connections in a storage area network

(76) Inventor: Mahmoud K. Jibbe, Wichita, KS (US)

Correspondence Address: LSI LOGIC CORPORATION, 1621 BARBER LANE, MS: D-106 LEGAL, MILPITAS, CA, 95035, US

(21) Appl. No.: 10/141,242

(22) Filed: May 8, 2002

(51) Int. Cl. G06F 15/173

(52) U.S. Cl. 709/224

(57) ABSTRACT

A system and method for isolating faulty connections in a storage area network, by identifying faulty passive connectivity components in both laboratory and customer site environments. Being independent of the operating system, protocol and components of the Storage Area Network (SAN) the method is passive with respect to live data transmissions within the SAN and is capable of testing the access and reach ability to all the active devices without impacting or changing the configuration and the setup parameters. The method enables the execution of a plurality of procedures including a host/client procedure, a host_switch procedure and an array controller procedure. The system may be a faulty connection and loss of access detection mechanism connected to the SAN or integrated within a SAN component device.

### FIELD OF THE INVENTION

The present invention generally relates to the field of failure detection within computer networks and particularly to a system and method for isolating faulty connections in a storage area network.

### BACKGROUND OF THE INVENTION

The diversity of the applications and the configuration complexity in a Storage Area Network (SAN) environment has presented a number of challenges in isolating failures. In bringing Fibre channel solutions to market, generally the focus of the user and the equipment manufacturers has been on how to isolate faults they believe have occurred in their products. For example, when a failure is detected a user such as, a lab technician, engineering support team member, customer and the like may point out that the problem is due to the functionality of one of the devices of the SAN, such as the host adapter, the switch, the hub or the array controller (e.g., disk array controller). Replacing such devices can be costly and time consuming and may not ensure proper functionality of the SAN.

However, this failure analysis is typically presented without checking the functionality of the passive connectivity components such as Giga-Bit Interface Convertors (GBICs), cables, connectors, device ports and the like. Failure of these connectivity components can render a SAN or the SAN fail-over capabilities inoperable. Consequently, the user may be unable to determine why the SAN is inoperable even though the intelligent components appear functional. Thus, the perception of the SAN reliability, access, serviceability, usability, integrity and redundancy capabilities may be severely impacted, even though such failure may only cause system down time with no loss of information.

Currently, there exists no method that assists users in isolating failures, whether at a lab or a customer site, for all the certified operating systems, protocols and topologies and avoids having any effect on the SAN capabilities with respect to live data transmissions. It may be beneficial to provide a system and method that a user may utilize to perform a failure isolation technique. This is of particular importance, for as the technology continues to mature and become more sophisticated so may the connectivity components designed to connect them into a single operational unit. Thus, the difficulty of isolating faulty connections without disrupting the operating system can be expected to increase.

Therefore, it would be desirable to provide a system and method for isolating faulty connections in a storage area network thereby allowing a user to easily identify faulty passive connectivity components and eliminate the unnecessary replacement of functional devices.

### SUMMARY OF THE INVENTION

Accordingly, the present invention is directed to a system and method for isolating faulty connections in a storage area network by identifying faulty passive connectivity components in a variety of environments such as, lab sites, customer sites and the like. The method is passive with respect to live data transmissions within the SAN, being independent of the operating system, protocol and components of the Storage Area Network (SAN), and is capable of testing the access and reach ability to active devices within the SAN without impacting or changing the configuration and the setup parameters.

In exemplary embodiments, the system and method may be implemented by an information handling system with a connectivity scan, coupled to the SAN for identifying and locating faulty connections and loss of access to devices. The connectivity scan enables the execution of a plurality of procedures upon the SAN, which provide a user the ability to identify and isolate faulty connections within a variety of passive connectivity components located in various sections of the SAN environment.

In another embodiment, the plurality of procedures includes a host/client procedure which issues a report exchange status (RES) request to a connectivity component listed in a host configuration, the host receives an accept response or no response from the connectivity component. The host then generates and stores a list of faulty connections based on the response by the connectivity components to the RES request. A host_switch procedure provides analysis of the list of possible faulty connections in order to determine if the failure is due to a connection between a host and a switch or the switch is faulty. This is accomplished by checking if the device under investigation logged to the switch or not. An array controller procedure transmits an echoing probe signal from an array controller along the faulty path indicated from the list of possible faulty connections to determine if there is a connection failure between the target component and the array controller component.

It is to be understood that both the forgoing general description and the following detailed description are exemplary and explanatory only and are not restrictive of the invention as claimed. The accompanying drawings, which are incorporated in and constitute a part of the specification, illustrate an embodiment of the invention and together with the general description serve to explain the principles of the invention.

### BRIEF DESCRIPTION OF DRAWINGS

The numerous advantages of the present invention may be better understood by those skilled in the art by reference to the accompanying figures in which:

FIG. 1 is an illustration of an exemplary embodiment of the present invention wherein a Storage Area Network (SAN) is shown;

FIG. 2. is a block diagram of an exemplary embodiment of the present invention wherein a section of the SAN including the connectivity scans are shown;

FIG. 3 is a flow chart of an exemplary embodiment of the present invention wherein the steps of application of the procedures implementable by the connectivity scan mechanism are shown;

FIG. 4 is a flow chart of an exemplary embodiment of the present invention wherein the steps for the execution of a host/client procedure are shown;

FIG. 5 is a flow chart of an exemplary embodiment of the present invention wherein the steps for the execution of a host_switch procedure are shown;

FIG. 6 is a flow chart of an exemplary embodiment of the present invention wherein the steps for the execution of an array controller procedure are shown; and

FIG. 7 is a block diagram illustrating an exemplary hardware architecture of an information handling system suitable for implementing the connectivity scan.

### DETAILED DESCRIPTION

The present invention provides a system and method for isolating faulty connections within a Storage Area Network (SAN) environment. Reference will now be made in detail to the presently preferred embodiments of the invention, examples of which are illustrated in the accompanying drawings.

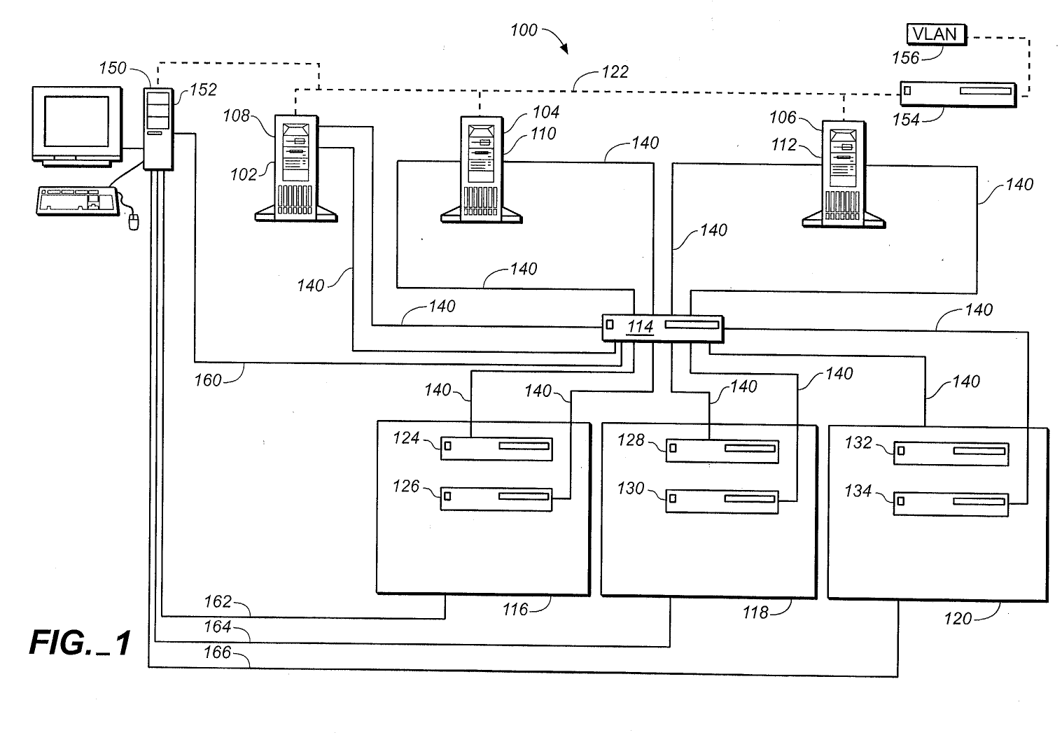

FIG. 1 illustrates a typical SAN Fibre Channel environment employing a system for isolating faulty connections in accordance with an exemplary embodiment of the present invention. However, the system and method employed by the current invention is applicable to any protocol, such as, SCSI, iSCSI, InfinBand and the like. As shown in FIG. 1, a Storage Area Network (SAN) 100 includes one or more servers 102, 104 and 106 with host adapters 108, 110 and 112 residing within, a switch 114 and storage arrays 116, 118 and 120 interconnected via network connection 122 and Fibre Channel cable 140. SAN 100 further includes an information handling system 150 and an Ethernet Hub 154, which forms a public network and uplinks with a Virtual Local Area Network (VLAN) 156. Information handling system 150, Ehternet Hub 154 and VLAN 156 are connected to the network via network connection 122. Information handling system 150 may be connected directly to switch 114 via Fibre Channel cable 160 and storage arrays 116, 118 and 120 via serial connections 162, 164 and 166, respectively. In embodiments of the invention, storage arrays 116, 118 and 120 are comprised of array controllers 124, 126, 128, 130, 132 and 134 and drive enclosures providing data storage. In exemplary embodiments, the storage arrays are disk storage arrays and the array controllers are disk array controllers, however, other storage system technologies such as tape array storage, network array storage (NAS), and the like, may be employed without departing from the spirit and scope of the present invention.

Servers 102, 104 and 106 may employ a variety of server operating systems, for example, Windows 2000, Windows NT, Solaris, Netware, IRIX, HP-UX, Linux, AIX and the like. The servers may each employ the same operating system or may each employ a different operating system forming a heterogeneous environment.

Host adapters, switches, hubs and array controllers are connected by Fibre Channel cable 140. Passive connectivity components, such as, Giga-Bit Interface Converters (GBICS), connectors, device ports and the like are employed. It is contemplated that other connectivity components may be employed by one of ordinary skill in the art without departing from the scope and spirit of the present invention.

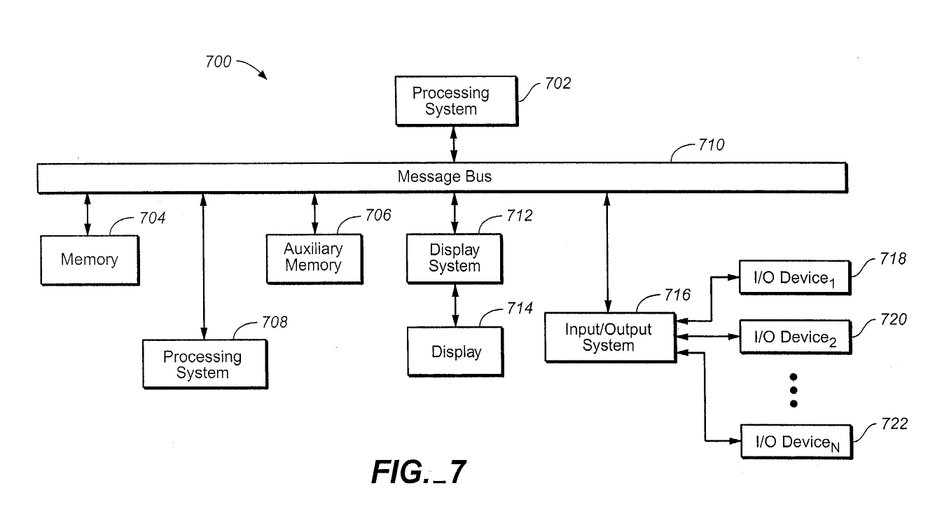

Information handling system 150 executing a connectivity scan 152 for isolating faulty connections due to faulty connectivity components, is provided. Connectivity scan 152 is implemented as executable programs resident in the memory of information handling system 150. Information handling system 150 may be a personal computer, handheld computer, and the like, configured generally as described in FIG. 7, discussed more fully below. There may be one or more information handling systems included in SAN 100. Information handling system 150 is coupled to the SAN via network connection 122. A user may also hot plug a device to a fabric switch or loop behind a switch to implement connectivity scan 152.

Information handling system 150 may be directly connected to switch 114 via a Fibre Channel cable 160. Further, information handling system 150 may be individually, directly connected to each of the storage arrays 116 through 120 via serial connections 162, 164 and 166. Fibre channel cable 160 and serial connections 162 through 166 provide information handling system 150 the ability to execute connectivity scan 152 directly upon switch 114 and storage arrays 116 through 120 as well as the ability to provide those devices with the necessary information so that they may execute an appropriate procedure of connectivity scan 152. Serial connections 162 through 166 and Fibre Channel cable 160 may employ other technologies as may be contemplated by one or ordinary skill in the art.

Connectivity scan 152 may be executed locally, as shown, or may be executed remotely over the uplinked VLAN 156. For example, an engineering support team member in location X may execute connectivity scan 152 on a customer SAN in location Y through the VLAN uplink 156 to Ethernet Hub 154, which serves the SAN of the customer.

The connectivity scan 152 provides multiple executable procedures for performing diagnostic functions as well as analysis functions on the various Fibre Channel connectivity components within SAN 100. These procedures may be utilized by a variety of users, such as, the customer, engineering support team members, systems integrators and the like. In the preferred embodiments of the invention the executable procedures include: (1) Host/Client procedure; (2) Host_Switch procedure; and (3) Array Controller procedure.

If SAN 100 does not include a device such as, information handling system 150 for implementation and execution of connectivity scan 152 then connectivity scan 152 may be executed from any one of servers 102, 104, 106 or all of the servers at the same time. Therefore, Host/Client procedure, Host_Switch procedure and Array Controller procedure may be executed from information handling system 150 and any one of or all of the servers 102 through 106. Host_Switch procedure may be executed from switch 114 and the Array Controller procedure may be executed from any one of the Array Controllers 124 through 134. Array Controller procedure may be only executed over SAN 100 or through the serial connections.

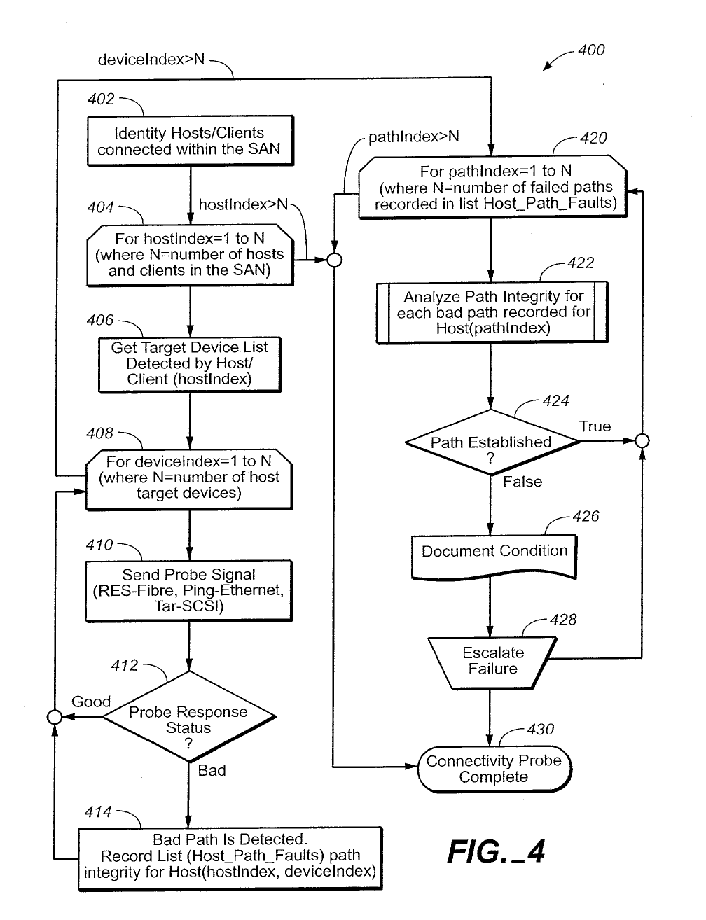

These procedures operate to isolate the faulty connection by the systematic elimination of connectivity components, which are functioning properly. In one embodiment the structured approach employed starts from the host, the initiator device, and tests the host access to other components, the target devices, in the SAN 100 system. The target devices in this example may include the switch, the hub, the array controller or other components connected within the SAN environment. The host transmits a signal probe with a response request to the target devices. If all target devices respond to the request then no fault is found and another signal probe, which originates at the array controller module, is sent out. The process and method is discussed fully in FIGS. 3 through 6 below. It is contemplated that the connectivity scan may be initiated from any device or component located within the SAN and target any other device or component within the SAN.

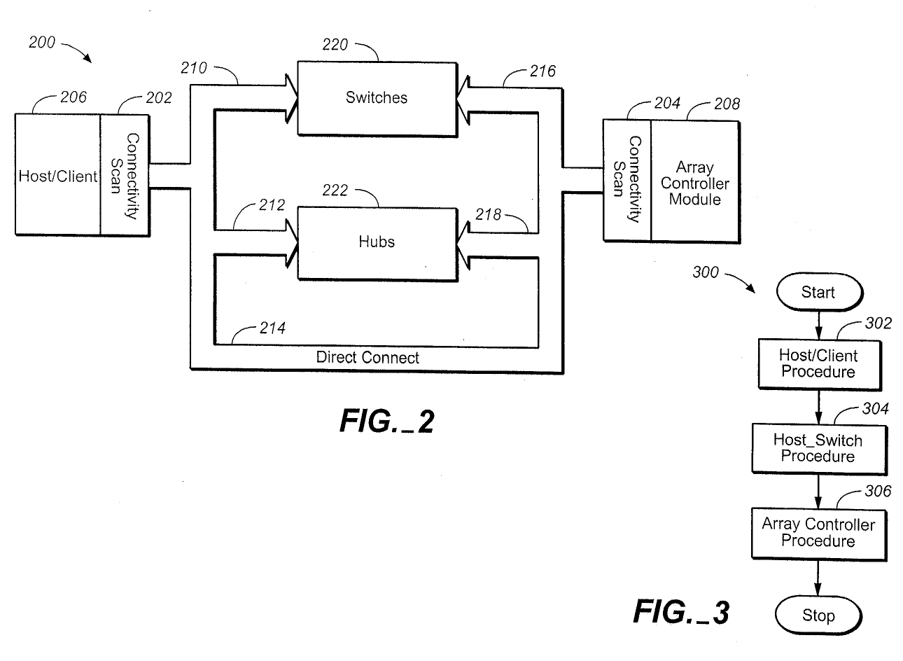

Referring now to FIG. 2, a block diagram of the present invention wherein a section 200 of SAN 100 including a connectivity scan 202 and 204 in accordance with an exemplary embodiment is shown. In this embodiment, connectivity scan 202 and 204 are integrated with Host/Client 206 and Array Controller Module 208. Thus, connectivity scan 202 and 204 do not require an additional information handling system for implementation. Three connectivity component pathways 210, 212 and 214 connect Host/Client 206 with Switches 220, Hubs 222 and Array Controller Module 208. Connectivity component pathway 214 provides a direct connection between Host/Client 106 and Array Controller Module 208. Two additional connectivity component pathways 216 and 218 connect Array Controller Module 208 with Switches 220 and Hubs 222. FIG. 2 shows one host/client connection, however, it may be understood that such connection schemes may be implemented with any number of host/clients within a SAN. Any number of cascaded hubs and cascaded switches may be included within the systems of FIGS. 1 and 2 without departing from the scope and spirit of the present invention.

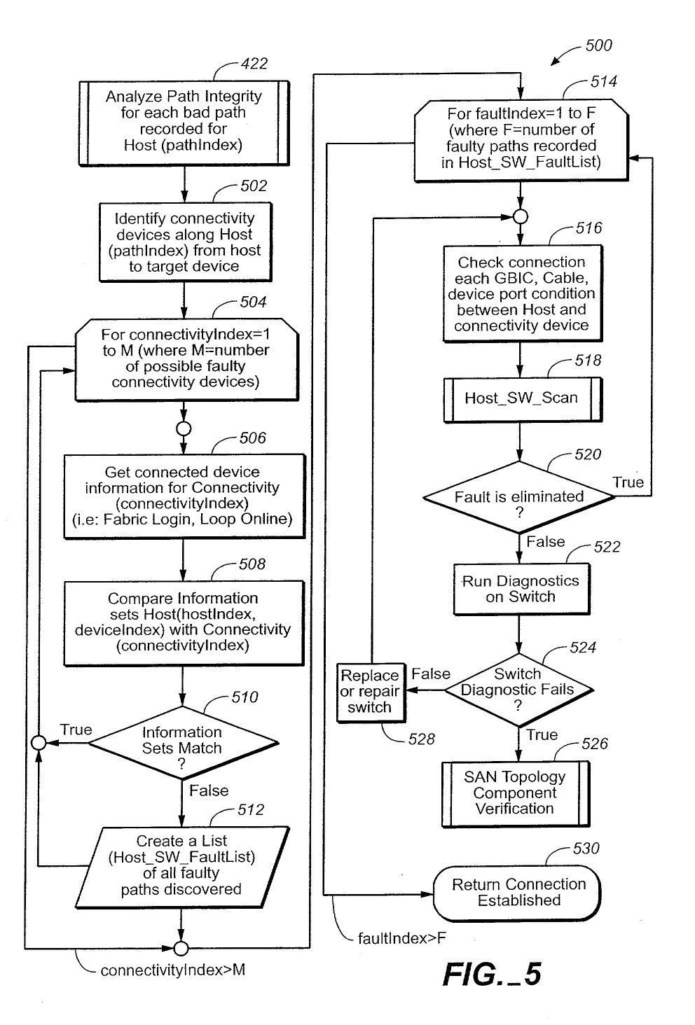

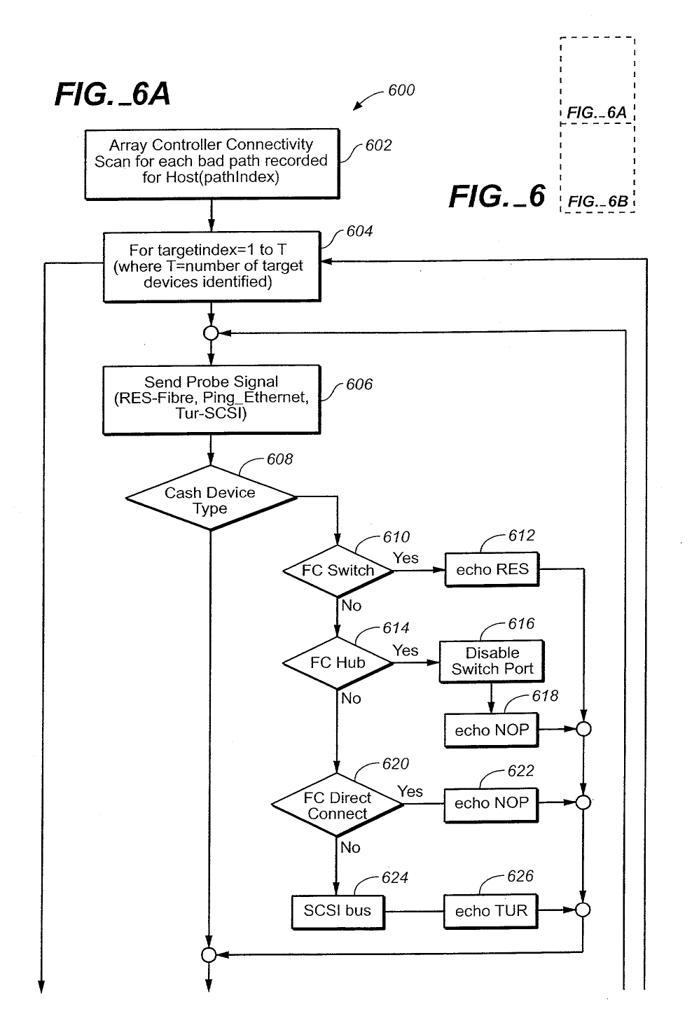

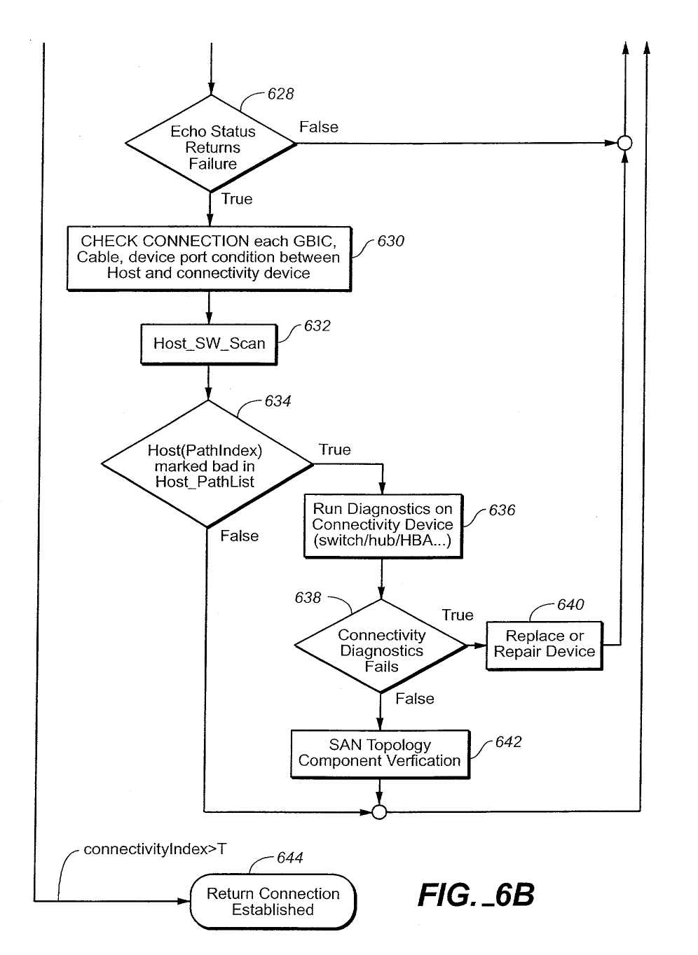

Connectivity scan mechanism 202, integrated with Host/Client 206, implements a host/client procedure and a host_switch procedure each of which is fully discussed in FIGS. 4 and 5 respectively. As shown in FIG. 1, each storage system 116, 118 and 120 includes two array controllers. Each array controller makes up an array controller module 208. As is more fully discussed below in FIG. 6, connectivity scan mechanism 204, integrated with array controller module 208, implements an array controller procedure 600.

Referring now to FIG. 3 a flow chart of an exemplary method of the present invention wherein the steps of faulty connection determination 300 of the procedures implementable by the connectivity scan mechanism are shown. Step 302 is the host/client procedure, which initiates diagnosis of faulty connections by sending a signal probe and then generating and storing a list of possible faulty connections, which is used by each of the following steps. The host/client procedure issues a report exchange status (RES) request to each device listed in the host configuration. If the target device returns an accept response to the RES request then the path is good. Otherwise, there may be a possible faulty connection with the path. The host generates the list of the possible faulty connections. This list is used by the components, such as the switch 220, the hub 222 and the array controller module 208 shown in FIG. 2.

Step 304 is the host_switch procedure, which provides analysis of the list and further refines the search for a faulty connection. This procedure uses the list generated in step 302 to determine if the failure is due to a connection between the host and the switch or a bad switch. The failure determination is refined by checking if the device under investigation is logged in to the switch or not. If the device is logged in then the fault is due to a connection between the host and the switch. If the switch shows the host adapter is logged in but not the device then the fault may be due to a connection between the switch and the device. If the switch shows the host adapter logged in and the device logged in then the procedure checks the functionality of the switch and rescans the devices.

Step 306 is the array controller procedure. By using the list generated in step 302 and not resolved by executing the Host_Switch of step 304, this procedure determines if there is a connection failure between the target and another connectivity component, such as the array controller module. This is determined by echoing probe signals from the array controller module along the faulty path indicated in the list generated by step 302. Based on the echo outcome one of three options may be executed. The options are (1) Checking the physical connections, (2) checking the connectivity components diagnostics and (3) verifying nominal operations or a verification process for each component along the 1/0 path.

Referring now to FIG. 4 a flow chart wherein the steps for the execution of a host/client procedure 400 in accordance with an exemplary method of the present invention are shown. Step 402 begins the procedure by identifying all the host/clients connected within the SAN. From the identification, step 404 generates a hostindex assigning a number to each host/client from 1 to N where N equals the number of host/clients in the SAN. Once each host/client has been identified then the procedure may either terminate the procedure by going to the connectivity probe complete step of 430 or go on to step 406. Step 406 generates a list of all target devices (e.g., switches, hubs, array controller modules, and the like) that are detected by an individual host/client within the SAN.

Step 408 generates a deviceindex assigning a number to each target device from 1 to N where N equals the number of host target devices. Step 410 sends the probe signal to a target device. In the Fibre Channel environment of this embodiment the signal is a report exchange status (RES) signal. It is contemplated that other technologies may be employed to enable SAN 100 and, therefore, other signals may be utilized, such as, Ping-Ethernet, Tur-SCSI (test unit ready command-SCSI) and the like. In step 412 the host/client is awaiting a response from the target device to which it sent the signal probe. If the host/client receives no response then in step 414 it acknowledges that a possible bad path is detected. From this bad path detected acknowledgment the host/client generates a “Record List (Host_Path Faults) path integrity for Host (hostindex, deviceindex),” which stores the possibly faulty connection path. The procedure loops back to steps 408, 410 and 412 for each target device until it has checked each target device. If the host/client detects more than one possibly faulty connection path it is recorded as described in step 414. If the host/client receives an accept response from the target device then the procedure loops back to step 408. At step 408 the procedure checks to see if there are any other target devices listed in the deviceindex, which need to be checked. If there are target devices which need to be checked then the procedure continues by sending the probe signal, of step 410, to the next target device. This loop from 408 through 412 keeps repeating until all devices are checked. When all target devices have been checked and all possibly faulty connections recorded then the procedure proceeds to step 420.

Step 420 establishes a pathindex assigning a number from 1 to N for each faulty path detected and recorded on the Record List Host_Path_Faults. This creates a Host(pathindex) of all the possibly faulty connections. In step 422 each path identified in the Host(pathindex) is analyzed for path integrity. In step 424 the procedure determines if the individual path has been established or not. If the path has not been established then the procedure proceeds to step 426 wherein the faulty path condition is documented. This documentation provides the list of faulty connections that is utilized by the Host_Switch procedure and the Array Controller procedure. Once documentation is complete, step 428 escalates the failure from a possibility to a verified faulty connection. After escalation the procedure loops back to step 420 to check the other pathways identified. If in step 424 a path is verified as having been established then the procedure loops back to step 420 to check the other pathways identified. When step 420 recognizes that it has checked all pathways and documented those that are faulty, then the procedure proceeds to step 430 and recognizes that the connectivity probe is complete.

Referring now to FIG. 5 a flow chart wherein the steps for the execution of a host_switch procedure 500 in accordance with an exemplary embodiment of the present invention are shown. This procedure starts from step 422 of FIG. 4 which is the analysis of path integrity for each bad path recorded for the Host(pathindex). In step 502 the procedure identifies the connectivity devices along the Host(pathindex) from the host to the target device. From this identification, step 504 generates a connectivityindex assigning a value from 1 to M for all the possible faulty connectivity devices. In step 506 connected device information, for each connected device identified in the connectivityindex, is gathered (i.e. Fabric Login, Loop Online). In step 508 the connectivityindex information set is compared against the hostindex and Host(deviceindex) information sets. In step 510 the procedure determines if the information sets match. If they match then the procedure loops back to step 504 and begins the process for another connectivity device. If the information sets do not match then the procedure proceeds to step 512 where the connectivity device is placed on a list, comprising all faulty paths discovered (Host_SW_Fault_List). After the connectivity device has been placed on the list the procedure loops back to step 504 and begins the process for another connectivity device. Once the procedure recognizes that all connectivity devices have been checked it proceeds to step 514.

Step 514 generates a faultindex assigning values from 1 to F for all faulty paths recorded in the Host_SW_Fault_List. In step 516 the procedure checks the connection of each connectivity component between the host and the connectivity device. The connectivity components may include Fibre cable, Gig-Bit Interface Converters and device ports such as disk drives, host adapters, array controllers or any communicating device in a SAN environment. The procedure in step 518 performs a scan of the Host Software indicated as Host_SW_Scan. This scan is performed automatically checking all connectivity devices between the host and the switch. It is contemplated that this scan may also be performed manually without departing from the spirit and scope of the present invention. If in step 520 the software scan determines that the fault has been eliminated as then the procedure loops back to step 514. If step 520 cannot eliminate the fault then a diagnostic is run on the switch in step 522. Step 524 determines if the switch diagnostic indicates the switch has failed or not. If the diagnostic fails, then the switch is functioning and the procedure performs a SAN Topology Component Verification in step 526. This is a verification that all connections between the host and the switch are functioning properly and may be indicative of a functional component failure. If the diagnostic is successful in identifying the switch as the fault source then step 528 indicates that the switch may be repaired or replaced at which point the procedure loops back to step 516. Once all faulty paths have been checked and the switch eliminated as the fault source or repaired or replaced the procedure establishes a return connection in step 530.

Referring now to FIG. 6 a flow chart wherein the steps for the execution of an array controller procedure 600 in accordance with an exemplary embodiment of the present invention are shown. Step 602 initiates an array controller connectivity scan for each bad path recorded for Host(pathindex). In step 604 the number of target devices identified are indexed and placed into a targetindex where values from 1 to T are assigned. After the target devices have all been identified then the array controller connectivity scan sends out a probe signal in step 606 to each target device. This is an echoing signal probe sent from the array controller module end of a communication path and tracking back towards a target device.

The type of signal sent depends on the device type, which is determined in step 608. The process, which takes place in step 608, of identifying the type of target device is represented by steps 610 through 626. Step 610 determines if the target device identified is a Fibre Channel switch. If step 610 determines the target device is a Fibre Channel switch then in step 612 the array controller procedure initiates an echo RES signal probe. If step 610 determines that the target device is not a Fibre Channel switch then the process proceeds to step 614. Step 614 determines if the target device identified is a Fibre Channel hub. If at step 614 it is determined that the target device is a Fibre Channel hub then in step 616 the procedure disables the switch port before proceeding to step 618 where it initiates an echo NOP (No Operation) signal probe. If step 614 determines that the target device is not a Fibre Channel hub then the process proceeds to step 620. Step 620 determines if the target device identified is a Fibre Channel array controller module where the host/client is directly connected with the array controller module. If step 620 determines that the target device is a Fibre Channel array controller module then step 622 initiates an echo NOP signal probe. If step 620 determines that the target device is not a Fibre Channel array controller module then the process proceeds to step 624. Step 624 applies to any remaining target device which is connected by a SCSI bus. These serially connected target devices, in step 626, have an echo TUR (Test Unit Ready) signal probe sent out to them.

These signal probes may be automated using a script language. The script language may be executed from information handling system 150 running serial software such as, PROCOM and the like. It is also contemplated that the script language may be executed from one or all of the servers 102 through 106 and may be executed across a network via Ethernet Hub 154, which may uplink VLAN 156.

Following each echo probe signal sent to a target device identified in the targetindex, step 628 determines if the echo status return has failed or not. If the echo status return is not a failure then the procedure loops back to step 606 and begins another series of signal probe scans. If the echo status return is a failure then in step 630 all connections between the host and the connectivity device are checked (i.e. cables, device port condition, Giga-Bit Interface Converters, and the like). After completing the check, step 632 initiates a Host_SW_Scan, like the one performed in step 518 of FIG. 5, where the software scans to identify the location of the fault.

The scan performed in step 632 then determines in step 634 if the Host(PathIndex) is marked bad in the Host_PathList. If the procedure determines that step 634 is false then it loops back to step 604. If the procedure determines that step 634 is true then in step 636 a diagnostic is run on the device(s) connecting the switch, hub and the like, and the components themselves. In step 638 the procedure determines if the connectivity diagnostic has identified a failed connectivity device. If the diagnostic has identified a failed connectivity device then step 640 directs the user to replace or repair the device and then loops back to step 606 to initiate an echo probe on another device. If the diagnostic fails to identify a faulty device then the procedure, in step 642, performs a SAN Topology Component Verification scan to verify that all connections are functional between the array controller and the target device. After it has finished the SAN Topology Component Verification scan the procedure then loops back to step 604.

Once the procedure has checked the connectivity of each target device and replaced or repaired any faulty connectivity components, which resulted in faulty connections, the procedure through step 604 proceeds to step 644 where a functioning return connection has been established. At this point the connectivity scan is complete with all faulty connections identified and returned to active status.

Referring now to FIG. 7, an exemplary hardware system generally representative of an information handling system is shown. The hardware system 700 is controlled by a central processing system 702. The central processing system 702 includes a central processing unit such as a microprocessor or microcontroller for executing programs, performing data manipulations and controlling the tasks of the hardware system 700. Communication with the central processor 702 is implemented through a system bus 710 for transferring information among the components of the hardware system 700. The bus 710 may include a data channel for facilitating information transfer between storage and other peripheral components of the hardware system. The bus 710 further provides the set of signals required for communication with the central processing system 702 including a data bus, address bus, and control bus. The bus 710 may comprise any state of the art bus architecture according to promulgated standards, for example, industry standard architecture (ISA), extended industry standard architecture (EISA), Micro Channel Architecture (MCA), peripheral component interconnect (PCI) local bus, standards promulgated by the Institute of Electrical and Electronics Engineers (IEEE) including IEEE 488 general-purpose interface bus (GPIB), IEEE 696/S-100, and so on. Other components of the hardware system 700 include main memory 704 and auxiliary memory 706. The hardware system 700 may further include an auxiliary processing system 708 as required. The main memory 704 provides storage of instructions and data for programs executing on the central processing system 702. The main memory 704 is typically semiconductor-based memory such as dynamic random access memory (DRAM) and/or static random access memory (SRAM). Other semi-conductor-based memory types include, for example, synchronous dynamic random access memory (SDRAM), Rambus dynamic random access memory (RDRAM), ferroelectric random access memory (FRAM), and so on. The auxiliary memory 706 provides storage of instructions and data that are loaded into the main memory 704 before execution. The auxiliary memory 706 may include semiconductor based memory such as read-only memory (ROM), programmable read-only memory (PROM), erasable programmable read-only memory (EPROM), electrically erasable read-only memory (EEPROM), or flash memory (block oriented memory similar to EEPROM). The auxiliary memory 706 may also include a variety of non-semiconductor-based memories, including but not limited to magnetic tape, drum, floppy disk, hard disk, optical, laser disk, compact disc read-only memory (CD-ROM), write once compact disc (CD-R), rewritable compact disc (CD-RW), digital versatile disc read-only memory (DVD-ROM), write once DVD (DVD-R), rewritable digital versatile disc (DVD-RAM), etc. Other varieties of memory devices are contemplated as well. The hardware system 700 may optionally include an auxiliary processing system 708 which may be an auxiliary processor to manage input/output, an auxiliary processor to perform floating point mathematical operations, a digital signal processor (a special-purpose microprocessor having an architecture suitable for fast execution of signal processing algorithms), a back-end processor (a slave processor subordinate to the main processing system), an additional microprocessor or controller for dual or multiple processor systems, or a coprocessor. It may be recognized that such auxiliary processors may be discrete processors or may be built in to the main processor.

The hardware system 700 further includes a display system 712 for connecting to a display device 714, and an input/output (I/O) system 716 for connecting to one or more I/O devices 718, 720, and up to N number of I/O devices 722. The display system 712 may comprise a video display adapter having all of the components for driving the display device, including video memory, buffer, and graphics engine as desired. Video memory may be, for example, video random access memory (VRAM), synchronous graphics random access memory (SGRAM), windows random access memory (WRAM), and the like. The display device 714 may comprise a cathode ray-tube (CRT) type display such as a monitor or television, or may comprise an alternative type of display technology such as a projection-type CRT display, a liquid-crystal display (LCD) overhead projector display, an LCD display, a light-emitting diode (LED) display, a gas or plasma display, an electroluminescent display, a vacuum fluorescent display, a cathodoluminescent (field emission) display, a plasma-addressed liquid crystal (PALC) display, a high gain emissive display (HGED), and so forth. The input/output system 716 may comprise one or more controllers or adapters for providing interface functions between the one or more I/O devices 718-722. For example, the input/output system 716 may comprise a serial port, parallel port, universal serial bus (USB) port, IEEE 1394 serial bus port, infrared port, network adapter, printer adapter, radio-frequency (RF) communications adapter, universal asynchronous receiver-transmitter (UART) port, etc., for interfacing between corresponding I/O devices such as a keyboard, mouse, trackball, touchpad, joystick, trackstick, infrared transducers, printer, modem, RF modem, bar code reader, charge-coupled device (CCD) reader, scanner, compact disc (CD), compact disc read-only memory (CD-ROM), digital versatile disc (DVD), video capture device, TV tuner card, touch screen, stylus, electroacoustic transducer, microphone, speaker, audio amplifier, etc. The input/output system 716 and I/O devices 718-722 may provide or receive analog or digital signals for communication between the hardware system 700 of the present invention and external devices, networks, or information sources. The input/output system 716 and I/O devices 718-722 preferably implement industry promulgated architecture standards, including Ethernet IEEE 702 standards (e.g., IEEE 702.3 for broadband and baseband networks, IEEE 702.3z for Gigabit Ethernet, IEEE 702.4 for token passing bus networks, IEEE 702.5 for token ring networks, IEEE 702.6 for metropolitan area networks, and so on), Fibre Channel, digital subscriber line (DSL), asymmetric digital subscriber line (ASDL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on. It may be appreciated that modification or reconfiguration of the hardware system 700 of FIG. 7 by one having ordinary skill in the art would not depart from the scope or the spirit of the present invention.

In the exemplary embodiments, the methods disclosed may be implemented as sets of instructions or software readable by a device. Further, it is understood that the specific order or hierarchy of steps in the methods disclosed are examples of exemplary approaches. Based upon design preferences, it is understood that the specific order or hierarchy of steps in the method can be rearranged while remaining within the scope and spirit of the present invention. The accompanying method claims present elements of the various steps in a sample order, and are not meant to be limited to the specific order or hierarchy presented.

It is believed that the system and method for isolating faulty connections in a storage area network of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof. It is the intention of the following claims to encompass and include such changes.

What is claimed is:

1. A method for isolating faulty connectivity components within a Storage Area Network (SAN) Fibre Channel environment, comprising:
executing a host/client procedure, for providing report exchange status (RES) information for a connectivity component listed in a host configuration, suitable for generating a list of possible faulty connections;
executing a host_switch procedure, for providing analysis of the list of possible faulty connections in order to determine if the failure is due to a connection between a host and a switch or the switch is bad; and
executing an array controller procedure, for transmitting an echoing probe signal from an array controller component along the faulty path indicated from the list of possible faulty connections to determine if there is a connection failure between a target component and a connectivity component.

2. The method of claim 1, wherein the step of executing a host/client procedure comprises the host issuing a report exchange status request to each connectivity component and the host receiving at least one of an accept response to the request and no response to the request and storing that response.

3. The method of claim 2, wherein the accept response indicates the connectivity components of the communication path is functional and no response indicates the connectivity components within the communication path are non-functional.

4. The method of claim 1, wherein the step of executing a host_switch procedure comprises checking if the connectivity component under investigation logged to the switch or not.

5. The method of claim 4, wherein the logged in device indicates the fault is due to a connection between the host and the switch and the logged in host indicates no faulty connection between the switch and the host and initiates a procedure which checks the functionality of the switch and rescans the connectivity components.

6. The method of claim 1, wherein the step of executing the array controller procedure is enabled if the fault is not resolved by executing the host_switch procedure.

7. The method of claim 1, wherein based on the echoing probe outcome one of three options is executed, comprising:
a checking physical connections option for determining if there is a failure of the physical equipment;
a checking connectivity component option for checking diagnostics and verifying nominal operations of the connectivity component; and
a verification process option which verifies that each component along the input/output (I/O) path is working properly.

8. The method of claim 1, wherein the connectivity components include gig-bit interface converters (GBIC), cables, connectors and device ports.

9. The method of claim 1, wherein the target component includes the switch, an array controller and a hub.

10. The method of claim 1, wherein the method is passive regarding data transmission and is independent of the operating system, protocol and components of the SAN.

11. A system for isolating faulty connectivity components within a Storage Area Network (SAN) Fibre Channel environment, comprising:
a plurality of Fibre Channel connectivity components connected with and connecting a plurality of Fibre Channel components; and
a connectivity scan mechanism,
wherein the connectivity scan mechanism is capable of providing report exchange status (RES) information suitable for indicating a list of possible faulty connectivity component exists; analyzing the information for determining a cause of the faulty connection; and furnishing a possible cause of the faulty connection.

12. The Storage Area Network (SAN) Fibre Channel system of claim 11, wherein a host/client procedure issues a report exchange status (RES) request to a connectivity component listed in a host configuration, the host receives an accept response or no response from the connectivity component and the host generates and stores a list of faulty connections based on the response by the connectivity components to the RES request.

13. The Storage Area Network (SAN) Fibre Channel system as claimed in claim 11, wherein the analysis and furnishing of a possible cause of the faulty connection is determined by at least one of a host_switch procedure and a array controller procedure.

14. The Storage Area Network (SAN) Fibre Channel system of claim 13, wherein the host_switch procedure provides analysis of the list of possible faulty connections in order to determine if the failure is due to a connection between a host and a switch or the switch is bad and comprises checking if the device under investigation logged to the switch or not.

15. The Storage Area Network (SAN) Fibre Channel system of claim 13, wherein the array controller procedure transmits an echoing probe signal from an array controller along the faulty path indicated from the list of possible faulty connections to determine if there is a connection failure between a target component and a connectivity component.

16. The Storage Area Network (SAN) Fibre Channel system of claim 15, wherein the target component includes the switch, an array controller and a hub.

17. The Storage Area Network (SAN) Fibre Channel system as claimed in claim 11, wherein the plurality of Fibre Channel connectivity components include gig-bit interface converters (GBIC), cables, connectors and device ports.

18. The Storage Area Network (SAN) Fibre Channel system as claimed in claim 11, wherein the plurality of Fibre Channel components comprise a host adapter, an array controller, a switch and a hub.

19. The Storage Area Network (SAN) Fibre Channel system as claimed in claim 11, wherein the connectivity scan mechanism is passive regarding data transmission and is independent of the operating system, protocol and components of the SAN.

20. A system for isolating faulty connectivity components within a Storage Area Network (SAN) Fibre Channel environment, comprising:
means for identifying a possible faulty connectivity component exists from a plurality of connectivity components;
means for determining if the faulty connection is due to at least one of a connection between a host and a switch and a faulty switch;
means for determining if the faulty connection is due to a connection between a target component and the connectivity component.

21. The system of claim 20, wherein the means for identifying a possible faulty connectivity component comprises executing a host/client procedure, wherein the host issues a report exchange status (RES) request to a connectivity component listed in a host configuration, the host receives an accept response or no response from the connectivity component and the host generates and stores a list of possible faulty connections based on the response by the connectivity components to the RES request.

22. The system of claim 20, wherein the means for determining if the faulty connection is due to at least one of a connection between the host and the switch and the faulty switch comprises executing a host_switch procedure, wherein the host_switch procedure comprises checking if the connectivity component under investigation logged to the switch or not and if the host logged to the switch or not.

23. The system of claim 20, wherein the means for determining if the faulty connection is due to a connection between a target component and the connectivity component comprises executing an array controller procedure, wherein the array controller procedure transmits an echoing probe signal from an array controller along the faulty path indicated from the list of possible faulty connections to determine if there is a connection failure between a target component and a connectivity component.

24. The system of claim 20, wherein the target component includes the switch, an array controller and a hub.

25. The system as claimed in claim 20, wherein the plurality of Fibre Channel connectivity components include gig-bit interface converters (GBIC), cables, connectors and device ports.

26. The system as claimed in claim 20, wherein the SAN includes a plurality of Fibre Channel components comprising a host adapter, an array controller, a switch and a hub.

27. The system as claimed in claim 20, wherein the SAN includes a connectivity scan mechanism capable of providing the aforementioned means and is passive regarding data transmission and is independent of the operating system, protocol and components of the SAN.

28. A system for isolating faulty connectivity components within a Storage Area Network (SAN) Fibre Channel environment, comprising:
a plurality of Fibre Channel components;
a plurality of Fibre Channel connectivity components connected with and connecting the Fibre Channel components; and
a plurality of executable procedures, each procedure providing means for determining the existence and location of the faulty connection.

29. The faulty connection and loss of access detection mechanism as claimed in claim 28, wherein the plurality of executable functions comprises:
a host/client procedure capable of issuing a report exchange status (RES) request to the plurality of connectivity components listed in a host configuration, the host receives an accept response or no response from the plurality of connectivity components and the host generates and stores a list of faulty connections based on the response by the plurality of connectivity components to the RES request;
a host_switch procedure capable of providing analysis of the list of possible faulty connections in order to determine if the failure is due to a connection between a host and a switch or the switch is bad and comprises checking if the device under investigation logged to the switch or not; and
an array controller procedure capable of transmitting an echoing probe signal from an array controller along the faulty path indicated from the list of possible faulty connections to determine if there is a connection failure between a target component and a connectivity component.

30. The system of claim 28, wherein the target component includes the switch, an array controller and a hub.

31. The system as claimed in claim 28, wherein the plurality of Fibre Channel connectivity components include gig-bit interface converters (GBIC), cables, connectors and device ports.

32. The system as claimed in claim 28, wherein the SAN includes a plurality of Fibre Channel components comprising a host adapter, an array controller, a switch and a hub.

33. The system as claimed in claim 28, wherein the SAN includes a connectivity scan mechanism capable of providing the aforementioned means and is passive regarding data transmission and is independent of the operating system, protocol and components of the SAN.

34. A system for isolating faulty connectivity components within a Storage Area Network (SAN) Fibre Channel environment, comprising:
a plurality of Fibre Channel components including a host adapter, an array controller, a switch and a hub;
a plurality of Fibre Channel connectivity components including gig-bit interface converters (GBIC), cables, connectors and device ports, connected with and connecting the Fibre Channel components;
a host/client procedure capable of issuing a report exchange status (RES) request to the plurality of connectivity components listed in a host configuration, the host receives an accept response or no response from the plurality of connectivity components and the host generates and stores a list of faulty connections based on the response by the plurality of connectivity components to the RES request;
a host_switch procedure capable of providing analysis of the list of possible faulty connections in order to determine if the failure is due to a connection between a host and a switch or the switch is bad and comprises checking if the device under investigation logged to the switch or not; and
an array controller procedure capable of transmitting an echoing probe signal from an array controller along the faulty path indicated from the list of possible faulty connections to determine if there is a connection failure between a target component and a connectivity component.

35. The system of claim 34, wherein the target component includes the switch, an array controller and a hub.

36. The system as claimed in claim 34, wherein the SAN includes a connectivity scan mechanism capable of providing the aforementioned means and is passive regarding data transmission and is independent of the operating system, protocol and components of the SAN.
